(19) United States
(12) Patent Application Publication
(10) Pub. No.: US 2026/0319505 A1
(43) Pub. Date: Oct. 15, 2026

(54) Local Confirmation

(71) Applicant: Autonomous Solutions, Inc., Mendon, UT (US)

(72) Inventors: Jaremy Butler, Mendon, UT (US); Eli Taylor, Mendon, UT (US); James Yonk, Mendon, UT (US); Mike Hornberger, Mendon, UT (US); Benjamin Call, Mendon, UT (US); Taylor Bybee, Mendon, UT (US); Mckay Colleni, Mendon, UT (US); Mckord Harris, Mendon, UT (US); Neal Darley, Mendon, UT (US)

(73) Assignee: Autonomous Solutions, Inc., Mendon, UT (US)

(21) Appl. No.: 19/462,788

(22) Filed: Jan. 28, 2026

Related U.S. Application Data
(60) Provisional application No. 63/751,978, filed on Jan. 31, 2025.

(51) Int. Cl. G05D 1/622; B60W 30/182; B60W 60/00; G05D 1/222; G05D 1/242; G05D 111/10

(52) U.S. Cl. CPC G05D 1/622; B60W 30/182; B60W 60/0059; G05D 1/222; G05D 1/242; G05D 2111/17

(57) ABSTRACT

Disclosed are autonomous work vehicles and methods for locally confirming the presence of obstacles within a hazard zone extending over an area near and/or adjacent to the autonomous work vehicle. The method may enable the autonomous work vehicle to resume autonomous operation after losing perception of the operating environment. The method may include activating an emergency stop (e-stop) mode after perceptual loss, entering a manual mode upon receiving first operator input, receiving second operator input indicating that no obstacles were found within the hazard zone, clearing a hazard grid after receiving second operator input, and activating an autonomous mode for autonomous operation of the vehicle. The method may include re-activating the e-stop mode and/or manual mode when the vehicle detects an obstacle within the hazard zone during autonomous operation, when too much time elapses between the first and second operator input, or when the clearing the hazard grid fails.

### BACKGROUND

Autonomous work vehicles are increasingly being used to perform useful work within operating environments. Autonomous work vehicles frequently rely on exteroceptive sensors (e.g., cameras, LiDAR, and radar) to detect obstacles and virtually reproduce the operating environment for navigation. Despite this, further advances for detecting and avoiding obstacles are needed to improve autonomous work vehicle operational safety and efficiency.

### SUMMARY

Disclosed are autonomous work vehicles and methods for locally confirming the absence of obstacles at or near the autonomous work vehicle prior to initiating and/or resuming autonomous operation. The autonomous work vehicle may comprise a steering control system for autonomously controlling a driving direction of the autonomous work vehicle, a speed control system for autonomously controlling a speed of the autonomous work vehicle, and one or more sensors, including a visual sensor. The visual sensor may comprise a LiDAR sensor.

The autonomous work vehicle may comprise one or more processors communicatively coupled with the one or more sensors, the steering control system, and the speed control system. The autonomous work vehicle may also comprise one or more computer-readable media having stored thereon instructions that when executed cause the one or more processors to implement a method for ensuring no obstacles are present at or near the autonomous work vehicle prior to autonomous operation.

The method may comprise activating an emergency stop (e-stop) mode of the autonomous work vehicle, wherein activation of the e-stop mode prevents autonomous movement of the autonomous work vehicle. The method may then comprise activating a manual mode of the autonomous work vehicle, such that the autonomous work vehicle may be driven via manual input by an operator physically present at the autonomous work vehicle. The method may then include receiving first operator input indicating a beginning of a manual search for obstacles within a hazard zone, wherein the hazard zone comprises an area within a representation of an operating environment immediately surrounding the autonomous work vehicle, and then after receiving first operator input, deactivating the e-stop mode and initiating a hazard timer. The method may then comprise receiving second operator input indicating no obstacles were found during the manual search within the hazard zone and, when second operator input is received before the hazard timer expires, activating a clear hazard mode of the autonomous work vehicle.

When the clear hazard mode is activated, the method may further comprise clearing a hazard grid of the autonomous work vehicle, wherein the hazard grid comprises a virtual representation of obstacles within the hazard zone, and wherein clearing the hazard grid removes all indications of obstacles within the hazard grid such that detection of obstacles is based only on reception of future visual sensor signal data. The method may also comprise, after the clear hazard mode is activated, receiving visual sensor signal data from the visual sensor indicating whether an obstacle is present within the hazard zone, and when no obstacles are detected within the hazard zone, activating an autonomous mode of the autonomous work vehicle and instructing the steering control system and the speed control system to drive the autonomous work vehicle along a path through the operating environment based on the visual sensor signal data.

The method may further comprise, after the hazard grid is cleared and when visual sensor signal data indicate an obstacle within the hazard zone, re-activating the e-stop mode of the autonomous work vehicle. The method may further comprise, when the hazard timer expires before receiving the second operator input, activating the e-stop mode of the autonomous work vehicle. Activation of the e-stop mode may prevent autonomous operation of an implement connected to the autonomous work vehicle.

The sensor field of view of the visual sensor may extend over at least a portion of the operating environment that corresponds to a circumference of the hazard zone within the representation of the operating environment. When the clear hazard mode is active, activation of the autonomous mode may be prevented until any and all operators have left the hazard zone. Activation of the clear hazard mode may further comprise initiating a clearing timer, and the method may further comprise activating the autonomous mode when no obstacles are detected within the hazard zone at or near a time the clearing timer expires.

The method may comprise, when the clear hazard mode is active, activating the autonomous mode based on input from a remote device. The first operator input may comprise pressing a button of the autonomous work vehicle. The method may further comprise, after activating the autonomous mode, when the visual sensor signal data indicates an obstacle is present within the hazard zone, re-activating the e-stop mode of the autonomous work vehicle.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 shows an illustrative computational system for performing functionality to facilitate implementation of embodiments described in this document.

FIG. 2 illustrates a block diagram of an example autonomous work vehicle communication system of the present disclosure.

FIG. 3 is a side view of an autonomous yard truck according to some embodiments.

FIG. 4 is a perspective view of an autonomous mower according to some embodiments.

FIG. 5 is a side view of an autonomous tractor according to some embodiments.

FIG. 6 shows a schematic top view of an autonomous work vehicle, a hazard zone, and an occlusion zone within a representation of the operating environment.

FIG. 7 illustrates a process for locally confirming the absence of obstacles within the hazard zone.

### DETAILED DESCRIPTION

Autonomous work vehicles frequently rely on exteroceptive sensors to map the environment in which the vehicle operates and to detect obstacles. However, portions of the field of view of these exteroceptive sensors may be occluded, even by portions of the autonomous work vehicle itself, and which may prevent the exteroceptive sensors from viewing all portions of the operating environment lying immediately adjacent or near the autonomous work vehicle. Generally, continuous observation by the exteroceptive sensors of portions of the operating environment lying further from the autonomous work vehicle may be sufficient to detect obstacles before they approach portions of the operating environment lying closer to the autonomous work vehicle.

However, breaks in sensor observation resulting from, for example, offline systems or components, additional occlusions, or moving obstacles entering occluded portions of the operating environment near the autonomous work vehicle may prevent the autonomous vehicle system from determining the presence or location of obstacles near to the autonomous work vehicle. The autonomous work vehicle may have gone offline for any number of reasons. This may include detecting something unknown within the sensor signal data, detecting malformed data, shadows, or other unknown objects, a processing time out, failure to receive an all clear message from the vehicle artificial intelligence, which may, for example, may be sent every 20 to 500 milliseconds, detection of a hazard, non-response of sensors, lack of position data (e.g., of the autonomous work vehicle), crashed processing nodes, instances wherein the obstacle detection system determines the autonomous work vehicle is off path or outside of safe zones, or other events.

To ensure that no obstacles are present near the autonomous work vehicle and to enable safe autonomous operation, a process implemented by the autonomous work vehicle and/or autonomous work vehicle systems is presented below to enable local confirmation of the absence of obstacles near the autonomous work vehicle. The process may include, upon detecting a break in sensor observation or detecting an obstacle near the autonomous work vehicle, activating an emergency stop of the autonomous work vehicle, receiving first operator input from a local operator indicating the beginning of a manual search, and receiving second operator input from a local operator indicating the successful completion of the manual search and that no obstacles are present near the autonomous work vehicle. The autonomous work vehicle may then wait for a local operator to distance themselves from the vehicle and may clear a hazard grid of all indicated obstacles, ensuring all indicated obstacles are newly detected, prior to beginning or resuming autonomous operation. If the manual search is not performed within a sufficiently short period of time, if the hazard grid fails to clear, or if an obstacle is detected sufficiently near the autonomous work vehicle during autonomous operation the autonomous work vehicle may again initiate an emergency stop, preventing driving of the autonomous work vehicle until a manual search has been successfully completed. This standardized process (describe more fully below) for locally confirming the absence of obstacles near the autonomous work vehicle may beneficially reduce the risk of harm to the vehicle, people, and objects within the operating environment and may facilitate operational efficiency and success.

As used herein, the term “local” may refer to actions, objects, or features located at the autonomous work vehicle, such as actions, objects, or features forming a part of the autonomous work vehicle.

As used herein, the term “remote” may refer to actions, objects, or features located or taking place away from the autonomous work vehicle, or not forming a part of the autonomous work vehicle.

As used herein, the term “visual sensor” may refer to a sensor (e.g., connected to the autonomous work vehicle) that produces signals representing the operating environment and which may be used to produce a representation of the operating environment. The visual sensor may comprise a LiDAR, radar, video camera, or other visual sensor.

As used herein, the term “occlude” or related terms may refer to obstructing the field of view of the visual sensor(s), such that the visual sensor(s) may be prevented from viewing the operating environment. Importantly, portions of the autonomous working vehicle may occlude the operating environment closest to the autonomous work vehicle from the visual sensor(s) field of view.

As used herein, the term “autonomous” or related terms may refer to the ability of the autonomous vehicle system to function independently, to make decisions and perform tasks without human intervention.

As used herein, the term “operational perception” may refer to the gathering of information within the operating environment by the autonomous work vehicle, for example, through one or more sensors, especially during autonomous driving. “Operational perception” may refer to generation of visual sensor signal data by the one or more sensors of the autonomous work vehicle that may be used to produce a virtual representation of the operating environment, and which enables the autonomous work vehicle to effectively perceive the operating environment.

As used herein, a “perceptual break” may refer to a period of time during which the autonomous work vehicle or autonomous vehicle system experiences a loss of operational perception, such that the virtual grid map used to navigate the autonomous work vehicle may not fully and/or accurately represent the operational environment.

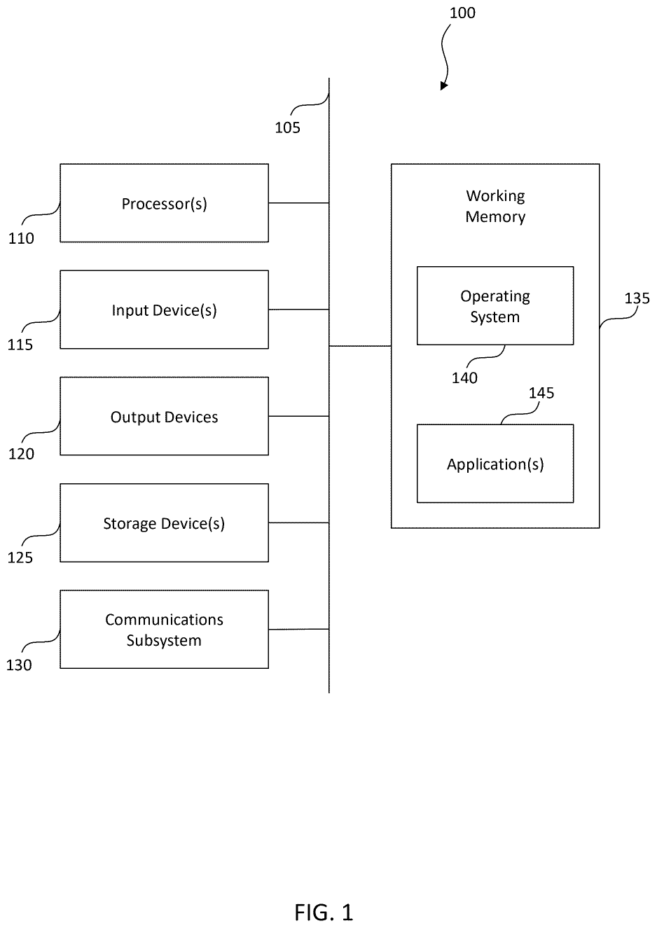

The computational system 100, shown in FIG. 1, can be used to perform any of the embodiments of the invention. For example, computational system 100 can be used to execute process 700. As another example, computational system 100 can be used to perform any calculation, identification, and/or determination described here. Computational system 100 includes hardware elements that can be electrically coupled via a bus 105 (or may otherwise be in communication, as appropriate). The hardware elements can include one or more processors 110, including without limitation one or more general-purpose processors and/or one or more special-purpose processors (such as digital signal processing chips, graphics acceleration chips, and/or the like); one or more input devices 115, which can include without limitation a mouse, a keyboard, and/or the like; and one or more output devices 120, which can include without limitation a display device, a printer, and/or the like.

The computational system 100 may further include (and/or be in communication with) one or more storage devices 125, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 100 might also include a communications subsystem 130, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 130 may permit data to be exchanged with a network (such as the network described below, to name one example), and/or any other devices described herein. In many embodiments, the computational system 100 will further include a working memory 135, which can include a RAM or ROM device, as described above.

The computational system 100 also can include software elements, shown as being currently located within the working memory 135, including an operating system 140 and/or other code, such as one or more application programs 145, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 125 described above.

In some cases, the storage medium might be incorporated within the computational system 100 or in communication with the computational system 100. In other embodiments, the storage medium might be separate from a computational system 100 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 100 and/or might take the form of source and/or installable code, which, upon compilation and/or installation on the computational system 100 (e.g., using any of a variety of generally available compilers, installation programs, compression/decompression utilities, etc.) then takes the form of executable code.

The computational system 100 may be configured to operate an autonomous work vehicle platform. The term “autonomous work vehicle”, and related terms (e.g., “autonomous vehicle”, “autonomous vehicle platform”), as used herein may include manned vehicles, remote control vehicles, and/or manual vehicles, etc. The autonomous work vehicle platform may comprise a steering mechanism in communication with the processor, where the processor communicates steering commands to the steering mechanism based on the status of the autonomous mode and/or the presence of obstacles within the hazard zone 640 (see below). The autonomous work vehicle platform may comprise a braking mechanism in communication with the processor, where the processor communicates braking commands to the braking mechanism based on the status of the autonomous mode and/or the presence of obstacles within the hazard mode (see below).

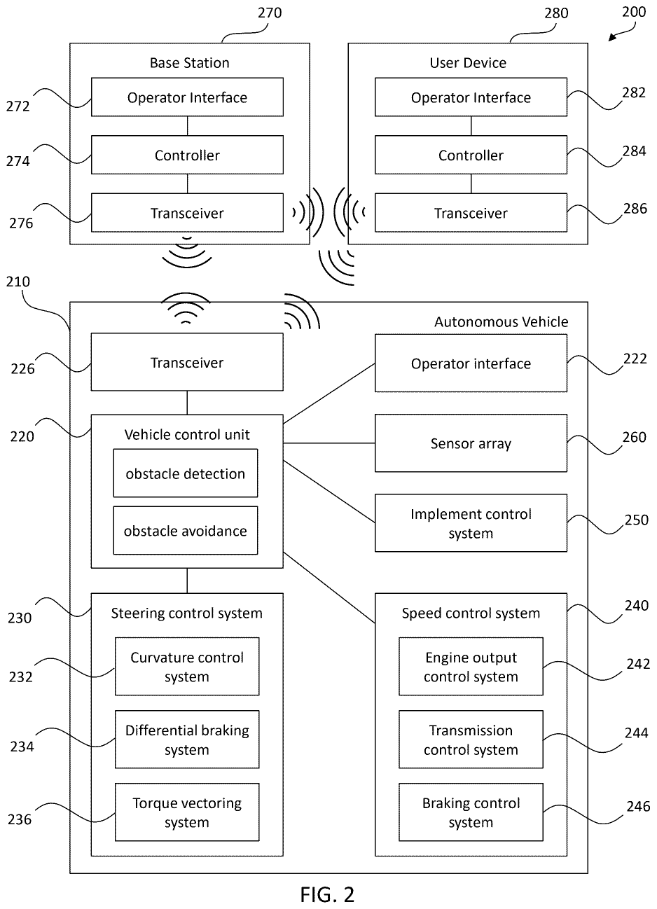

FIG. 2 is a block diagram of a communication and control system 200 that may be utilized in conjunction with the systems and methods of the disclosure. The communication and control system 200 may include a vehicle control unit (VCU) 220 which may be mounted on an autonomous work vehicle 210. The autonomous work vehicle 210, for example, may include a yard truck, loader, wheel loader, track loader, dump truck, digger, backhoe, forklift, mower (e.g., lawn, field, or brush mower), or other vehicle. The communication and control system 200, for example, may include any or all components of computational system 100 shown in FIG. 1.

For example, the autonomous work vehicle 210 may include a steering control system 230 that may control a direction of movement of the autonomous work vehicle 210. The steering control system 230, for example, may include any or all components of computational system 100 shown in FIG. 1.

The autonomous work vehicle 210, for example, may include a speed control system 240 that controls the speed, acceleration, and deceleration of the autonomous work vehicle 210. The speed control system 240, for example, may control the speed of the autonomous work vehicle 210 based on map data, control algorithms, obstacle detection, start and/or stop points, input from the operator (e.g., a remote operator), etc. The speed control system 240, for example, may include any or all components of computational system 100 shown in FIG. 1.

The autonomous work vehicle 210, for example, may include an implement control system 250 that may control operation of an implement towed by the autonomous work vehicle 210, integrated within the autonomous work vehicle 210, or coupled to the autonomous work vehicle 210. The implement control system 250, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 250, for example, may include any or all components of computational system 100 shown in FIG. 1.

The vehicle control unit 220 may be communicatively coupled with the steering control system 230, the speed control system 240, and/or the implement control system 250. The vehicle control unit 220, for example, may include any or all of the components shown in FIG. 1. The vehicle control unit 220, for example, may be integrated into a single controller or may include a plurality of distinct components or controllers. The vehicle control unit 220 may also be coupled with one or more sensors from the sensor array 260 and receive sensor data from the sensor array 260.

The vehicle control unit 220, for example, may be used to control various aspects of the vehicle 210 such as, for example, sending instructions to the steering control system 230, implement control system 250, speed control system 240, etc. The vehicle control unit 220, for example, may include a vehicle artificial intelligence (VAI) that may include one or more processors that execute one or more algorithms, including process 700 disclosed below.

The vehicle control unit 220, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 260 or from a base station 270 (described below).

The vehicle control unit 220, for example, may be an electronic controller with electrical circuitry configured to process data from the various components of the autonomous work vehicle 210. The vehicle control unit 220 may include a processor, such as the processor 110, and a working memory 135. The vehicle control unit 220 may also include one or more storage devices, storage media, and/or other suitable components of computational system 100. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 220, for example, may include any or all the components shown in FIG. 1.

The vehicle control unit 220, for example, may include a volatile memory, such as random access memory (RAM), and/or a nonvolatile memory, such as ROM (e.g., working memory 135, storage device 125, and/or other computer-readable media). The memory may store a variety of information and may be used for various purposes. For example, the memory may store processor-executable instructions (e.g., firmware or software) for the vehicle control unit 220 to execute, such as instructions for calculating a drivable path plan, and/or controlling the autonomous work vehicle 210 (e.g., for implementing processes 700 below). The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 230, for example, may include a curvature rate control system 232, a differential braking system 234, a steering mechanism, and a torque vectoring system 236 that may be used to steer the autonomous work vehicle 210. The curvature rate control system 232, for example, may control a direction of an autonomous work vehicle 210 by controlling a steering control system of the autonomous work vehicle 210 with a curvature rate, such as an Ackerman style autonomous work vehicle, 210 or articulating vehicle. The curvature rate control system 232, for example, may automatically rotate one or more wheels or tracks of the autonomous work vehicle 210 via hydraulic or electric actuators to steer the autonomous work vehicle 210. By way of example, the curvature rate control system 232 may rotate front wheels/tracks, rear wheels/tracks, and/or intermediate wheels/tracks of the autonomous work vehicle 210 or articulate the frame of the vehicle, either individually or in groups. The differential braking system 234 may independently vary the braking force on each lateral side of the autonomous work vehicle 210 to direct the autonomous work vehicle 210. Similarly, the torque vectoring system 236 may differentially apply torque from the engine to the wheels and/or tracks on each lateral side of the autonomous work vehicle 210. While the illustrated steering control system 230 includes the curvature rate control system 232, the differential braking system 234, and the torque vectoring system 236, the steering control system 230 may include one or more of these systems. Further examples may include a steering control system 230 having other and/or additional systems to facilitate turning the autonomous work vehicle 210 such as an articulated steering control system, a differential drive system, and the like.

The speed control system 240, for example, may include an engine output control system 242, a transmission control system 244, and a braking control system 246. The engine output control system 242 may vary the output of the engine to control the speed of the autonomous work vehicle 210. For example, the engine output control system 242 may vary a throttle setting of the engine, a fuel/air mixture of the engine, a timing of the engine, and/or other suitable engine parameters to control engine output. In addition, the transmission control system 244 may adjust gear selection within a transmission to control the speed of the autonomous work vehicle 210. Furthermore, the braking control system 246 may adjust the braking force to control the speed of the autonomous work vehicle 210. While the illustrated speed control system 240 includes the engine output control system 242, the transmission control system 244, and the braking control system 246, the speed control system 240 may include one or two of these systems. The speed control system 240, for example, may also include other systems and/or additional systems that may be used to control the speed of the autonomous work vehicle 210.

The implement control system 250, for example, may control various parameters of the implement towed by and/or integrated within the autonomous work vehicle 210. For example, the implement control system 250 may instruct an implement controller via a communication link, such as a CAN bus, ISOBUS, Ethernet, wireless communications, and/or Broad R Reach type Automotive Ethernet, etc.

The implement control system 250, for example, may instruct an implement controller to adjust a penetration depth of at least one ground engaging tool of an agricultural implement, which may reduce the draft load on the autonomous work vehicle 210.

The implement control system 250, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc. The implement control system 250, as another example, may instruct the implement controller to adjust a shovel height, a shovel angle, a shovel position, etc.

The communication and control system 200, for example, may include a sensor array 260. The sensor array 260, for example, may facilitate determination of condition(s) of the autonomous work vehicle 210 and/or the operating environment. For example, the sensor array 260 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel and/or track a ground speed of the autonomous work vehicle 210. The sensors may also monitor operating levels (e.g., temperature, fuel level, etc.) of the autonomous work vehicle 210. Furthermore, the sensors may monitor conditions in and around the operating environment, such as temperature, weather, wind speed, compass, humidity, and other conditions. The sensors of the sensor array 260, for example, may detect physical objects in the operating environment, such as a parking stall, a material stall, accessories, other vehicles, obstacles, environmental features, or other object(s) that may be in the area surrounding the autonomous work vehicle 210.

The sensor array 260, for example, may include a velocity sensor which may include one or more of an inertial measurement unit, a compass, a GPS sensor, a wheel encoder, a tachometer, a camera, a radar, etc. The sensor array 260, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous work vehicle 210 may include an operator interface 222 for controlling the vehicle. The operator interface 222, for example, may be communicatively coupled to the vehicle control unit 220 and configured to present data from the autonomous work vehicle 210 via a display. Display data may include data associated with operation of the autonomous work vehicle 210, data associated with operation of an implement, a position of the autonomous work vehicle 210, a speed of the autonomous work vehicle 210, a desired path, a drivable path plan, a target position, and/or a current position, etc. The operator interface 222 may enable an operator to control certain functions of the autonomous work vehicle 210 such as starting and stopping the autonomous work vehicle 210, inputting a desired path, etc. The operator interface 222, for example, may enable the operator to input parameters that cause the vehicle control unit 220 to adjust the drivable path plan. For example, the operator may provide an input requesting that the desired path be acquired as quickly as possible, that an off-path normal error be minimized, that a speed of the autonomous work vehicle 210 remain within certain limits, and/or that a lateral acceleration experienced by the autonomous work vehicle 210 remain within certain limits, etc. In addition, the operator interface 222 (e.g., via the display, or via an audio system (not shown), etc.) may alert an operator if the desired path cannot be achieved, for example.

The communication and control system 200, for example, may include a base station 270 having a base station controller 274 located remotely from the autonomous work vehicle 210. For example, the control functions of the vehicle control unit 220 may be distributed between the vehicle control unit 220 of the autonomous work vehicle 210 and the base station controller 274. The base station controller 274, for example, may perform a substantial portion of the control functions of the vehicle control unit 220. For example, a first transceiver 226 positioned on the autonomous work vehicle 210 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 276 at the base station 270. The base station controller 274, for example, may calculate drivable path plans and/or output control signals to control the curvature control system 232, the speed control system 240, and/or the implement control system 250 to direct the autonomous work vehicle 210 toward the desired path, for example. The base station controller 274 may include a processor and memory device having similar features and/or capabilities as the processor and the memory device discussed previously. Likewise, the base station 270 may include an operator interface 272 having a display, which may have similar features and/or capabilities as the operator interface 222 and the display discussed previously.

In some embodiments, one or both of the base station 270 and/or the autonomous work vehicle 210 may be in communication with a user device 280. A user device 280 may include a phone, tablet, laptop, or computer. The user device 280 may similarly include an operator interface 282 which may include similar features and capabilities as operator interfaces 222, 272 described above. Additionally, or alternatively, the user device 280 may comprise a controller 284 that may include the same or similar features, components, and/or characteristics as the controller 274 of the base station 270. For example, the user device controller 274 may calculate drivable path plans, output control signals to control the curvature control system 232, the speed control system 240, and/or the implement control system 250 to direct the autonomous work vehicle 210. The user device 280, for example, can include an application that allows the user (e.g., a remote operator) to communicate commands to the autonomous work vehicle 210 (e.g., via a transceiver 286) and/or receive information about the autonomous work vehicle 210. Alternatively, or additionally, the user device 280, for example, can include an application that allows the operator to observe the autonomous work vehicle 210 move through a map of the operating environment where the autonomous work vehicle operates.

The user device 280, for example, may include an application that can receive an indication associated with the remote operator or which can receive other user or operator inputs. The user device 280, for example, may include an application that can display any of the information disclosed in this document.

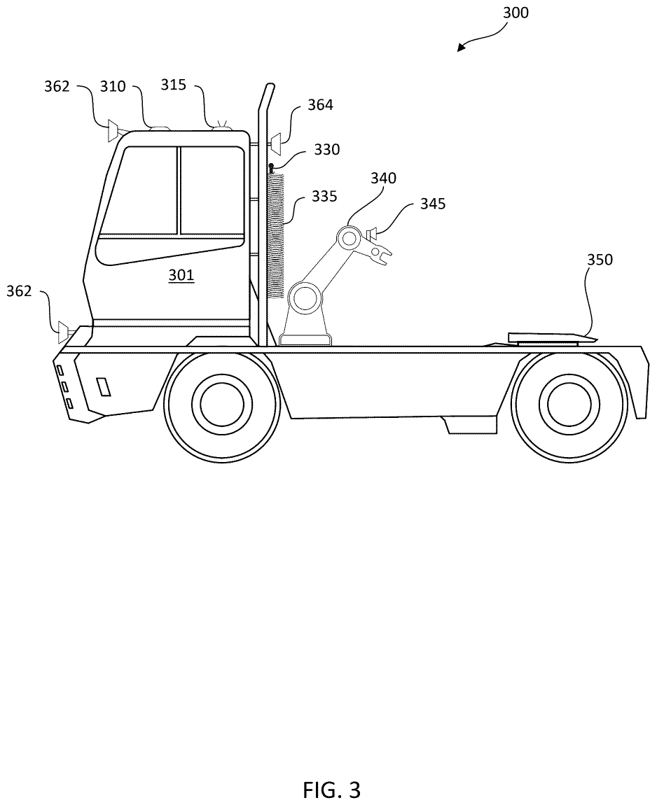

FIG. 3 is a side view of an autonomous yard truck 300 according to some embodiments. The autonomous yard truck 300 includes a cab 301 that may be used to drive the autonomous yard truck 300 manually. The autonomous yard truck 300 may include one or more of the components shown in FIG. 2. The autonomous yard truck 300 may also include a brake system, an engine, a transmission, steering, sensor array, etc. such as, for example, as shown in FIG. 2.

In some embodiments, the autonomous yard truck 300 may include a sensor array that includes sensors 362 (e.g., sensor array 260) disposed at various locations on the autonomous yard truck 300 such as, for example, on the cab 301, bumper, housing, frame, etc. The sensors 362 may include infrared sensors, ultrasonic sensors, magnetic sensors, radar sensors, LiDAR sensors, terahertz sensors, sonar sensors, cameras, etc. The sensor array of the autonomous yard truck 300 may also include one or more backup sensors 364 such as, for example, infrared sensors, ultrasonic sensors, magnetic sensors, radar sensors, LiDAR sensors, terahertz sensors, sonar sensors, cameras, etc.

In some embodiments, the autonomous yard truck 300 may include a spatial locating device (or GPS) antenna 310. In some embodiments, the autonomous yard truck 300 may include a transceiver antenna 315.

In some embodiments, the autonomous yard truck 300 may include one or more hoses 335 that can connect with a trailer such as, for example, two or three hoses. Each hose may have a hose connector 330 that can connect with a trailer hose connector. For example, the one or more hoses 335 of the autonomous yard truck 300 may include a service brake hose, an emergency brake hose, and/or a refrigerant hose.

In some embodiments, the autonomous yard truck 300 may include a robotic arm 340 disposed on the back bed of the autonomous yard truck 300. The robotic arm 340 may include any type of robotic arm. The robotic arm 340, for example, may exert high torque or high pressure sufficient to connect the hose connector 330 with the trailer hose connector. The hose connector 330 and/or the trailer hose connector may comprise a glad-hand connector. In some embodiments, when the autonomous yard truck 300 is not coupled with a trailer, the hose connector 330 may be positioned in a storage rack at some point on the autonomous yard truck 300 such as, for example, on the rear of the cab 301.

In some embodiments, the robotic arm 340 may include one or more arm sensors 345 such as, for example, infrared sensors, ultrasonic sensors, magnetic sensors, radar sensors, LiDAR sensors, terahertz sensors, sonar sensors, cameras, etc. The arm sensor 345, for example, may produce data that can be used to identify the location of a hose connector 330 and/or a trailer hose connector. The arm sensor 345, for example, may produce data that can show that a hose connector 330 and/or a trailer hose connector are sufficiently coupled.

In some embodiments, the autonomous yard truck 300 may include a fifth-wheel coupling 350. The fifth-wheel coupling 350, for example, may be raised or lowered with a fifth-wheel coupling boom. FIG. 3 shows the fifth-wheel coupling 350 in a lowered position. The fifth-wheel coupling 350 may couple with a kingpin of a trailer.

When the fifth-wheel coupling 350 is coupled with a kingpin and the fifth-wheel coupling 350 is in the raised position, the legs of the trailer may lift off the ground (e.g., automatically). This may allow the autonomous yard truck 300 to pull the trailer without individually raising the trailer legs.

In some embodiments, the robotic arm 340 and/or the arm sensor 345 may be coupled with a thermal management system. A thermal management system may, for example, be coupled with a thermal management system associated with the autonomous yard truck 300 such as, for example, coupled with the cab heating/cooling system and/or the engine heating/cooling system. A thermal management system may, for example, be an independent system that heats and/or cools the robotic arm 340 and/or the arm sensor 345. A thermal management system may, for example, keep the temperature of the robotic arm 340 and/or the arm sensor 345 between about 32° F. and about 100° F.

In some embodiments, the autonomous yard truck 300 may include a deployable shade coupled with the back of the cab 301. The deployable shade, for example, may be used to screen the sun and/or other lighting from the arm sensor 345 and/or the one or more backup sensors 364. The deployable shade, for example, may include an umbrella configuration or an awning configuration. The deployable shade, for example, may be coupled with the roof or an upper portion of the cab.

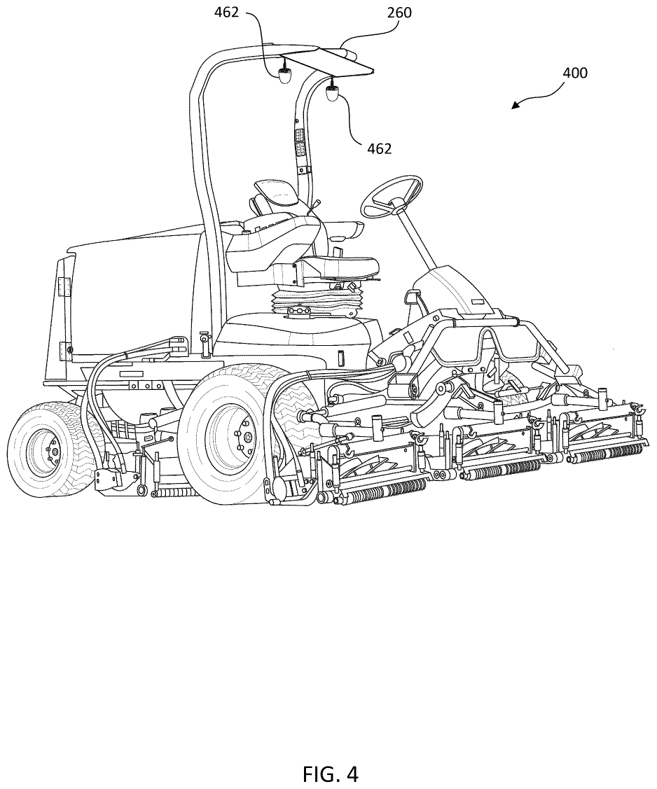

FIG. 4 is a sideview of an example autonomous mower 400, which may include all or some of the components of autonomous work vehicle 210. The autonomous work vehicle in this document may include the autonomous mower 400. Any type of mower or blades may be used, such as a disc mower. The autonomous mower 400, for example, may include a sensor array 260 (or multiple sensor arrays 260), including sensors 462. The sensor array 260 may include, for example, one or more LiDAR, radar, and/or video cameras. The video cameras, for example, may include 360 degree cameras, a front facing camera, and/or a back facing camera.

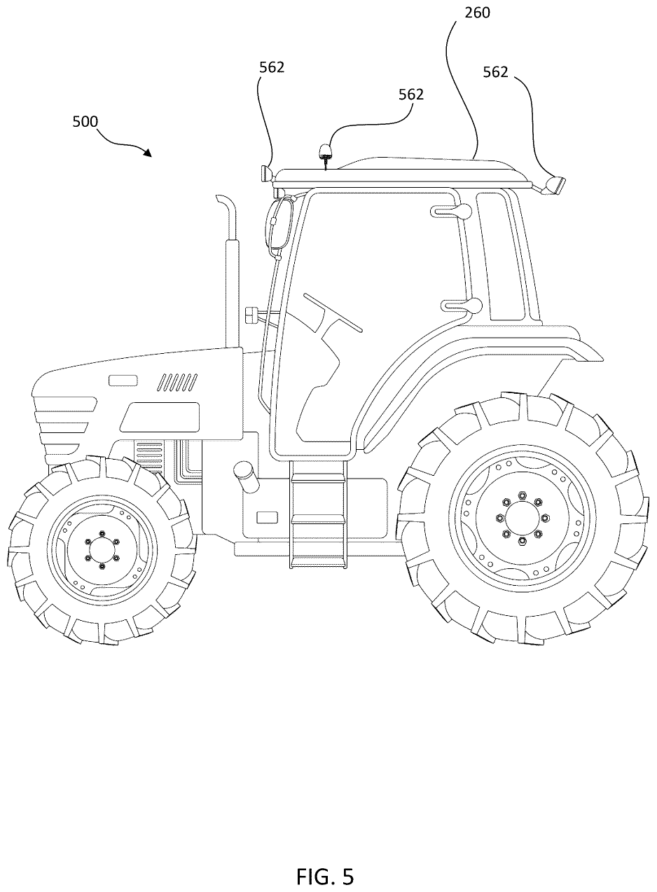

FIG. 5 is a sideview of an example autonomous tractor 500, which may include all or some of the components of autonomous work vehicle 210. The autonomous work vehicle in this document may include the autonomous tractor 500. In this example, the autonomous tractor 500 may include standard tractor equipment and/or components. The autonomous tractor 500 may include or be coupled with any kind of implement such as, for example, a plow, disc plow, reel mower, dumper, lift, bucket, shovel, blade, and/or cutter, etc. The autonomous tractor 500, for example, may include a sensor array 260 (or multiple sensor arrays 260), including sensor(s) 562. The sensor array 260 may include, for example, one or more LiDAR, radar, and/or video cameras. The video cameras, for example, may include 360 degree cameras, a front facing camera, and/or a back facing camera.

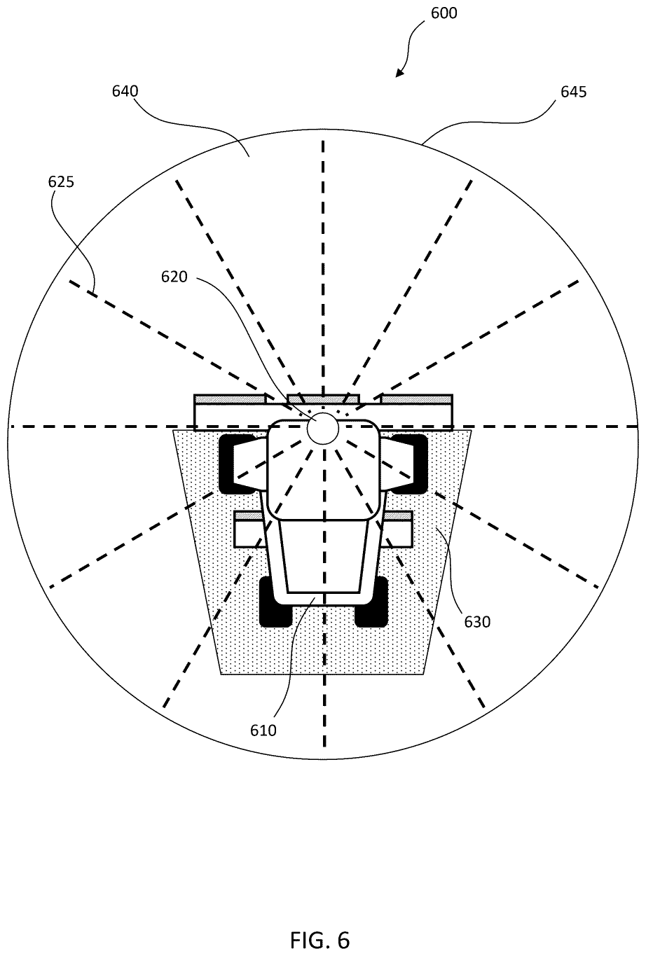

FIG. 6 illustrates a schematic top view 600 of an autonomous work vehicle 610 comprising an autonomous mower. FIG. 6 also illustrates that a hazard zone 640 may extend from and surround the autonomous work vehicle 610. The autonomous work vehicle 610 may comprise one or more sensors, including a visual sensor 620 (e.g., 2D or 3D LiDAR sensor, radar, stereo camera, etc.) for producing signals used to generate a representation of the operating environment and for detecting obstacles within the operating environment. The autonomous work vehicle 610 may comprise one or more than one visual sensor 620. The visual sensor 620 may be disposed about the autonomous work vehicle 610. For example, the visual sensor 620 may be disposed at or near a top surface of the autonomous work vehicle 610 (as shown in FIG. 6) to provide the visual sensor 620 with a relatively large sensor field of view (FOV) 625 (e.g., to enable a maximum field of view of the visual sensor). In another example, the visual sensor 620 may be disposed at or near a bottom surface of the autonomous work vehicle 610. The visual sensor 620 may be disposed towards a front (or towards a primary driving direction) of the autonomous work vehicle 610 or disposed towards a rear (or towards a reverse of the primary driving direction) of the autonomous work vehicle 610.

FIG. 6 presents an illustration of the manner in which the autonomous work vehicle 610 and the hazard zone 640 may be represented within a virtual representation (e.g., a virtual map) of the operating environment. The autonomous work vehicle 610 may be represented by a first polygon. The first polygon may resemble a round (e.g., circular, elliptical), triangular, quadrilateral (e.g., square or rectangular), or other polygonal shape, or may resemble an irregular shape. The first polygon may resemble the autonomous work vehicle 610, such that the shape of the first polygon approximates a profile of the autonomous work vehicle 610. The cross-sectional area of the first polygon within the virtual map may approximate the cross-sectional area (e.g., a planar surface area or planar cross-section) of the autonomous work vehicle 610 within the operating environment. The first polygon can include multiple vertices and have any shape. The first polygon can be created based on operator input or drawn by an operator. The first polygon can move throughout the virtual map of the operating environment as the autonomous work vehicle 610 moves throughout the operating environment.

The hazard zone 640 may represent an area within the operating environment immediately surrounding the autonomous work vehicle 610 and/or extending from the autonomous work vehicle 610 to an outer limit 645. Obstacles detected within the hazard zone 640 may pose significant and/or substantial risk of harm to the safe operation of the autonomous work vehicle 610. That is, the hazard zone 640 may represent a location where obstacles present a hazard (e.g., a risk of collision) to the autonomous work vehicle 610. When an obstacle is detected within the hazard zone 640 the autonomous work vehicle 610 may immediately stop and/or activate an operational mode to prevent collision or other encounter with the detected obstacle and thereby reduce the risk of harm to the detected obstacle and/or the autonomous work vehicle 610 itself.

The hazard zone 640 may comprise a second polygon or other shape that delimits a portion of the operating environment. For example, the hazard zone 640 may comprise a profile having a round (e.g., circular, elliptical, or oval), quadrilateral (e.g., square, rectangular, trapezoidal, or rhomboidal), triangular shape, or may comprise a profile resembling a polygon having 5, 6, 7, 8, 9, or 10 sides, or more than 10 sides. In some embodiments, the profile of the hazard zone may resemble an irregular shape and/or may resemble a profile of the autonomous work vehicle 610). The normal length or distance between the first polygon and the second polygon can be called the off-path error.

The hazard zone 640 may extend to areas within the virtual representation that lie adjacent to the autonomous work vehicle 610. The hazard zone 640 may extend to an outer limit 645 surrounding the autonomous work vehicle 610. The outer limit 645 of the hazard zone 640 may extend a set distance from the autonomous work vehicle 610 in all directions. For example, the hazard zone 640 may extend from the autonomous work vehicle 610 by approximately 3 feet, approximately 5 feet, approximately 8 feet, approximately 10 feet, approximately 12 feet, approximately 15 feet, approximately 18 feet, approximately 20 feet, approximately 25 feet, approximately 30 feet, or approximately 50 feet, or may extend within a range having any two of the foregoing as endpoints. The autonomous work vehicle 610 may not be centered within the hazard zone 640 along one or more directions. For example, the hazard zone 640 may extend further from the front of the autonomous work vehicle 610 than from a rear of the autonomous work vehicle 610. This may provide a greater distance between the autonomous work vehicle 610 and obstacles detected in front of the autonomous work vehicle 610, beneficially providing the autonomous work vehicle 610 additional distance to slow (when moving in a forwards direction) to prevent collision between the obstacle and the autonomous work vehicle 610.

FIG. 6 also illustrates that the sensor FOV 625 may extend at least to the limits of the hazard zone 640. The sensor FOV 625 may also extend beyond the hazard zone 640 to detect obstacles before they enter the hazard zone 640. The hazard zone 640 (and the occlusion zone 630, described below), may refer to portions of the operating environment and/or may refer to an area within the virtual map.

During operation (e.g., in autonomous or manual operation), the autonomous work vehicle 610 may be activated in one or more than one mode. In some embodiments, the autonomous work vehicle 610 may be activated in several modes, or may be activated in no modes. The modes may control the behavior of the autonomous work vehicle 610, including the steering and speed control systems, and/or of the one or more sensors. The modes may similarly control the actions available to the autonomous vehicle (e.g., in either manual or autonomous operation). For example, the autonomous mode may control the ability of the autonomous work vehicle 610 to autonomously operate the steering and speed control systems to drive the autonomous work vehicle 610 through the operating environment, wherein an activated autonomous mode enables the autonomous vehicle system to autonomously operate the autonomous work vehicle 610 and a deactivated autonomous mode prevents the autonomous vehicle system from autonomously operating the autonomous work vehicle 610.

Each mode may have an active state and an inactive state. In some embodiments, the active state may enable the autonomous work vehicle 610 to perform a set of behaviors and the inactive state may prevent the autonomous work vehicle 610 from performing the set of behaviors. In some embodiments, the active state may enable the autonomous work vehicle 610 to perform a first set of behaviors and the inactive state may enable the autonomous work vehicle 610 to perform a second, different set of behaviors. Any and/or each mode may have an enabled state, wherein the mode may be activated and/or deactivated, and a disabled state, wherein the mode is locked in a deactivated state, or wherein the mode may not be activated and/or deactivated from its current state.

The modes of the autonomous work vehicle 610 may include an autonomous mode, a manual mode, an emergency stop (e-stop) mode, and/or a clear hazard mode. The autonomous mode, when activated, may enable the VCU 220 to instruct the steering and/or speed control systems to autonomously drive the autonomous work vehicle 610 through the operating environment (e.g., based on visual sensor signal data generated by the visual sensor 620). When deactivated, the autonomous mode may prevent the VCU 220 to instruct the steering and/or speed control systems to autonomously drive the autonomous work vehicle 610 through the operating environment.

The manual mode, when activated, may enable a human operator (present at the autonomous work vehicle 610, such as in a driver's seat of the autonomous work vehicle 610, or remotely from the autonomous work vehicle 610) to drive the autonomous work vehicle 610. When deactivated, the manual mode may prevent a human operator from driving the autonomous work vehicle 610.

The e-stop mode may, when activated, prevent movement of autonomous work vehicle 610. Specifically, the e-stop mode may prevent a human operator (local or remote) from driving the autonomous work vehicle 610 and may prevent the VCU 220 from autonomously instructing the steering and/or speed control systems to drive the autonomous work vehicle 610. This may prevent any accidental movement of the autonomous work vehicle and may be activated when an obstacle is detected sufficiently close to the autonomous work vehicle 610 (e.g., within the hazard zone 640) that the obstacle presents a risk of collision or harm to the autonomous work vehicle 610. When deactivated, the e-stop mode may not prevent movement of the autonomous work vehicle 610. In some embodiments, the e-stop mode may not be disabled, such that the autonomous work vehicle 610 may never be prevented from activating the e-stop mode during active autonomous operation and an obstacle is found within the hazard zone 640.

In some embodiments, the e-stop mode, when activated, may prevent operation and/or movement of an implement connected to the autonomous work vehicle 610, or may immobilize or shut down an implement connected to the autonomous work vehicle 610, and deactivation of the e-stop mode may correspondingly re-enable mobilization, operation, and/or movement of the implement. Activation of the e-stop mode may automatically induce disabling and/or deactivating of the autonomous mode, such that autonomous mode of the autonomous work vehicle 610 may not be activated or remain in an active state. The clear hazard mode may represent an intermediate mode wherein movement of the autonomous work vehicle 610 is prevented (e.g., the e-stop mode may still be active), but wherein the clear hazard mode may be deactivated (e.g., automatically) based on the presence and/or completion of exit conditions (e.g., the expiration of the clearing timer, receiving third operator input, or upon a determination that all human operators have left the hazard zone 640, as more fully described below). The clear hazard mode may additionally, or alternatively, enable the VCU 220 to access and/or clear the hazard grid or other navigational systems. The clear hazard mode may, before deactivation or automatically (e.g., as part of a confirmation process) enable and/or activate the autonomous mode.

The hazard grid may refer to a virtual representation of at least a portion of the operating environment, such as the portion of the operating environment within the sensor FOV 625 and/or portions of the operating environment that have passed within the sensor FOV 625 during performance of the operational task. Specifically, the hazard grid may indicate, based on visual sensor signal data received from the visual sensor 620, the presence and/or position of obstacles within the sensor FOV 625 and/or within the operating environment, particularly within the hazard zone 640. “Clearing” the hazard grid may refer to removing all indications of obstacles within the hazard grid. This may ensure that the autonomous vehicle system of the autonomous work vehicle 610 (or, for example, a remote operator) relies on visual sensor signal data received only after the hazard grid was cleared (i.e., future visual sensor signal data) to indicate the presence and/or location of obstacles within the hazard zone 640.

FIG. 6 also illustrates an occlusion zone 630 that may be present within the operating environment. The occlusion zone 630 may represent a portion of the operating environment that is occluded from the sensor FOV 625 of the visual sensor 620. As shown, the occlusion zone 630 may extend over a portion of the operating environment adjacent to the autonomous work vehicle 610 within the hazard zone 640. This may occur, for example, when portions of the autonomous work vehicle 610 obstruct the view of the operating environment from the sensor FOV 625. For example (as shown in FIG. 6), a visual sensor 620 disposed towards a top and front of the autonomous work vehicle 610 may have a sensor FOV 625 occluded by rear portions of the autonomous work vehicle 610. In another example, a visual sensor 620 disposed towards a bottom and rear of the autonomous work vehicle 610 may have a sensor FOV 625 occluded by driving wheels and/or implements (e.g., mower reels) of the autonomous work vehicle 610. Because the occlusion zone 630 may not be observed by the visual sensor 620, the potential presence of objects within the occlusion zone 630 may present the greatest risk of collision and resulting harm.

The autonomous work vehicle 610 may operate based on the assumption that during autonomous operation of the autonomous work vehicle 610 an obstacle may not enter the occlusion zone 630 without traversing the outer limit 645 of the hazard zone 640. Because an obstacle can only enter the occlusion zone 630 by crossing the outer limit 645 of the hazard zone 640, the autonomous work vehicle 610 may assume continued safe operation when the visual sensor 620 continues to observe the full circumference of the outer limit 645 of the hazard zone 640 (and/or portions of the hazard zone 640 extending in all directions from the autonomous work vehicle 610) and no obstacles are detected entering the hazard zone 640 across the outer limit 645. That is, during autonomous operation of the autonomous work vehicle, when autonomous operation is functioning correctly, the autonomous work vehicle 610 should be steered around obstacles and precautions or maneuvers should be performed for preventing obstacles from entering the hazard zone 640, with the result that the autonomous work vehicle 610 may activate an emergency stop (e-stop) when an obstacle is detected within the hazard zone 640 to prevent risk of collision.

However, problems may arise when a break in adequate visual sensor perception occurs. Inadequate visual sensor perception (e.g., a perceptual break) may occur when the visual sensor 620 loses continuous observation of the outer limit 645 of the hazard zone 640 (or at least portions of the operating environment surrounding the autonomous work vehicle 610 and the occlusion zone 630). This may happen, for example, on or before startup of the autonomous work vehicle 610 when the visual sensor 620 is inactive, when the visual sensor 620 experiences an outage, error, or malfunction preventing the generation of accurate visual sensor signal data, or when environmental conditions occlude the sensor FOV 625. An outage of the visual sensor 620 may comprise moments wherein visual sensor signal data is not received by the VCU or received by a base station (e.g., Mobius station) in communication with the autonomous work vehicle 610. The outage may occur during a sleep mode of the autonomous work vehicle 610 when the visual sensor 620 is inactivated (and not providing visual sensor signal data). In some embodiments, the visual sensor signal data may be relied upon to accurately detect obstacles only when the autonomous work vehicle 610 moves through the operating environment, such that inadequate visual sensor perception may occur when the autonomous work vehicle 610 remains stationary for an extended period of time.

The above situations may require a human operator to verify that no obstacles are present within the hazard zone 640, including the occlusion zone 630, before autonomous operation of the autonomous work vehicle 610 is enabled and/or activated. In some embodiments, the human operator may be physically present within the operating environment and/or hazard zone 640 to verify the absence of obstacles within the hazard zone 640. In some embodiments, the human operator may receive images generated by on-board sensors (i.e., sensors connected to the autonomous work vehicle 610, such as a video camera) or by other vehicles in the operating environment to verify the absence of obstacles within the hazard zone 640. For example, images of the occlusion zone 630 and/or hazard zone 640 may be generated by an aerial vehicle (e.g., aerial drone) and sent to the human operator.

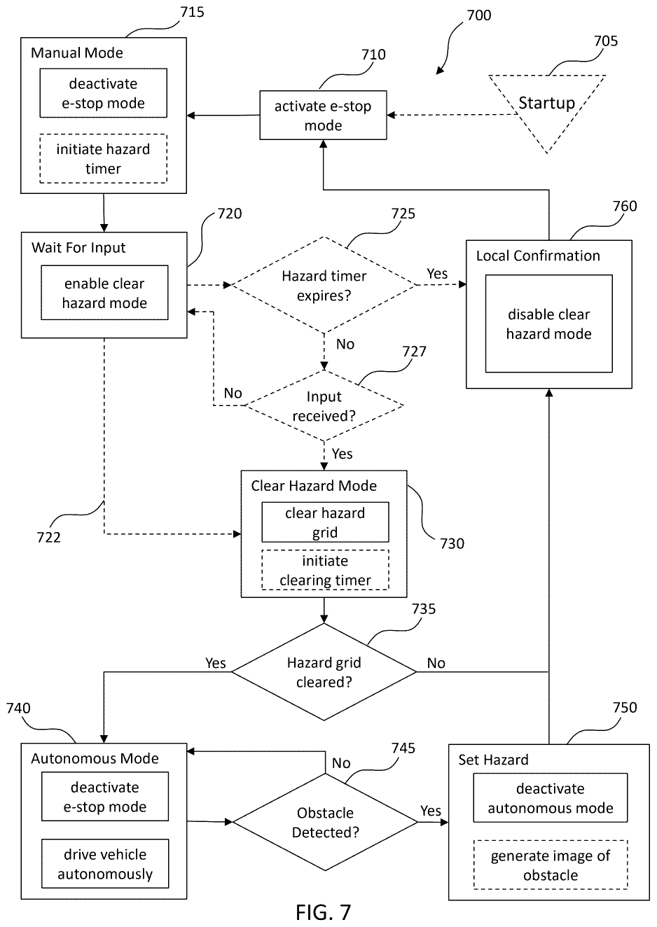

FIG. 7 illustrates a schematic of process 700 for locally confirming the absence of obstacles within the hazard zone. The process 700 may begin at step 705 wherein the autonomous work vehicle 610 resumes operational perception after a perceptual break. For example, the autonomous work vehicle 610 may resume operational perception after a perceptual break experienced at startup. Upon startup, the autonomous work vehicle 610 may resume operational perception. (Steps within FIG. 7 displayed in dashed outlines may be more optional or variable than steps depicted in solid outlines, or may represent one of two or more paths available when proceeding through process 700.) Step 705 may represent a resumption of operational perception (e.g., startup) that may occur in other instances, such as waking from a sleep mode or an inactive mode, or resuming activity after an e-stop.

The perceptual break occurring before the resumption of operational perception may make the hazard grid unreliable for the purpose of navigating the autonomous work vehicle 610. That is, during the perceptual break one or more obstacles may have moved into the hazard zone 640 (or the hazard zone 640 may have moved to include obstacles if the autonomous work vehicle 610 was moved during the perceptual break, such as a perceptual break of the visual sensor 620 occurring during manual driving of the autonomous work vehicle 610) and the visual sensor signal data generated by the visual sensor(s) 620 may not be sufficient to detect the one or more obstacles. For example, the obstacle may be located within the occlusion zone 630 or detection of the one or more obstacles may require visual sensor signal data from multiple sensor fields of view (e.g., visual sensor signal data sent as the sensor FOV moves with the autonomous work vehicle 610). To limit the risk of harm to the autonomous work vehicle 610 and/or the obstacle, the process 700 may proceed to step 710 wherein the e-stop mode of the autonomous work vehicle 610 is activated, such that the autonomous work vehicle 610 may not be autonomously driven. In some embodiments, activation of the e-stop mode may automatically deactivate a manual mode of the autonomous work vehicle 610, such that the autonomous work vehicle 610 may not be manually driven, at least until further input is received.

Because the hazard zone 640 may be in an indeterminate state (e.g., the presence and/or position of obstacles within the hazard zone 640 may be unknown or not completely known) and because the indeterminate state of the hazard zone 640 induced by the perceptual break may not be remedied by on-board sensors of the autonomous work vehicle 610 (because of the occluded portion of the hazard zone 640 represented by the occlusion zone 630), manual verification of the hazard zone 640 may be required.

The process 700 may proceed to step 715 wherein the manual mode of the autonomous work vehicle 610 is activated, such that the autonomous work vehicle 610 may be manually driven by a human operator. The manual mode may be activated by a local input at the autonomous work vehicle 610, such as by pressing a button or other input of the autonomous work vehicle 610 by a human operator that has approached the autonomous work vehicle 610. In some embodiments, the manual mode may be activated by a remote input, such as an input to remote device (e.g., by a remote operator) and the autonomous work vehicle 610 may be driven remotely by a remote operator. In such embodiments, remote input to activate the manual mode may only be possible when simultaneous view of the autonomous work vehicle 610 (e.g., by a separate visual sensor not connected to the autonomous work vehicle 610) is provided to a remote operator. In some embodiments, the manual mode may be activated only by a local input at the autonomous work vehicle 610. Activation of the manual mode may automatically induce deactivation of the e-stop mode, such that the autonomous work vehicle 610 may be manually driven by a human operator, but may not activate the autonomous mode, such that autonomous driving of the autonomous work vehicle 610 is not possible.

The manual mode may be provided, at least in part, to enable a human operator to inspect the hazard zone 640 for obstacles. Input for activating the manual mode may comprise a first operator input (with second and third operator input potentially receivable to the autonomous vehicle system) and may indicate to the autonomous vehicle system that a manual search for obstacles within the hazard zone 640 has begun. The manual search may be performed by a human operator present within the vicinity of the autonomous work vehicle 610 (e.g., within the hazard zone 640). A successful manual search may indicate that a human operator has confirmed that no obstacles are present within the hazard zone 640. In some embodiments, the visual sensor signal data may indicate the presence and/or location of the human operator and the process 700 may not proceed to activation of the autonomous mode if the visual sensor signal data received from the visual sensor(s) does not indicate that the human operator has traveled around the autonomous work vehicle 610 to inspect the perimeter of the autonomous work vehicle 610 for obstacles. In some embodiments, a remote human operator may inspect the hazard zone 640 for obstacles using a remote device. For example, the human operator may receive images of the hazard zone 640 surrounding the autonomous work vehicle 610 obtained from the visual sensors of a second vehicle, such as an aerial vehicle (e.g., aerial drone). Images produced from the second vehicle may be analyzed to verify that the images do contain the autonomous work vehicle 610 and the hazard zone 640 and that the produced images are generated from sufficient angles of view around the autonomous work vehicle 610 and within a sufficiently short period of time to confirm the manual search.

The process may continue to step 720 wherein the autonomous work vehicle 610 waits for additional input (i.e., second operator input) that indicates that no obstacles are present (or that no obstacles were found by the human operator) within the hazard zone 640. At step 720, the autonomous vehicle system may enable the clear hazard mode, such that the clear hazard mode may be activated upon successful completion of the manual search. When the second operator input is received, the process 700 may proceed via path 722 to step 730 wherein the clear hazard mode of the autonomous work vehicle 610 is activated.

In some embodiments, the process 700 may proceed via step 725 wherein the autonomous vehicle system requires the manual search to be performed within a specified time period (e.g., a relatively short time period) before activating the clear hazard mode. This may ensure that the indication that no obstacles are present within the hazard zone 640 is sufficiently reliable—that no more than a minimum of time was available for obstacles to enter the hazard zone 640 during the search—and may prevent the autonomous work vehicle 610 from waiting endlessly until input is received. Performing the manual search within a relatively short period of time may ensure that any obstacles entering or leaving the hazard zone 640 are accounted for and that the presence of obstacles within the hazard zone is current, such that the second operator input may be relied upon. Applying a time limit may also ensure that the vehicle system does not waste the vehicle battery looking or waiting for input and encourages a human operator to remain prompt and alert during the manual search.

This may be accomplished by, when the process 700 proceeds to activating the manual mode, step 715 may also comprise initiating a hazard timer and requiring that the manual search be performed before the hazard timer expires. The hazard timer may comprise a countdown (or, for example, a timer counting up to a threshold) at the expiration of which, if second operator input is not received, directs the process 700 to step 760 for reinitiating local confirmation. Expiration of the hazard timer may indicate that the manual search could not be performed sufficiently quickly to be relied upon. The hazard timer may expire within (or may count up to a threshold of) 15, 30, 45, 60, 75, 90, 105, 120, 180, 240, or 300 seconds, or an amount of time within a range having any two of the foregoing values as endpoints. The amount of time within which the hazard timer expires may be adjustable within the settings of the autonomous vehicle system.

Proceeding to step 760 may indicate that the status or presence of obstacles present within the hazard zone 640 is not sufficiently verified to ensure safe autonomous operation of the autonomous work vehicle 610. At step 760, the manual mode may be deactivated, preventing manual driving of the autonomous work vehicle 610. Similarly, at step 760 the clear hazard mode may be deactivated (if in an active state) and disabled, such that the autonomous work vehicle 610 may not be operated autonomously.

If the hazard timer has not expired (e.g., by reaching a timer threshold), the process 700 may continue to step 727 wherein the autonomous work vehicle 610 verifies whether additional input (i.e., second operator input) has been received. If additional input is not received, then the process 700 reverts back to step 720 for the autonomous work vehicle 610 to wait for input. If additional input is received, then the process 700 may continue to step 730 and activate the clear hazard mode.

In other embodiments, the process 700 may proceed from step 720 during which the autonomous work vehicle 610 waits for input to activating the clear hazard mode at step 730 without initiating and waiting for a hazard timer by proceeding via path 722. Whether the process proceeds via path 722 or step 725 may be controlled by adjustable settings of the autonomous vehicle system.

The clear hazard mode may represent an intermediate mode and may be required to be active to activate the autonomous mode. When the clear hazard mode is activated, it may be assumed that a manual search has been made of the hazard zone 640 after a perceptual break and before full autonomous operation of the autonomous work vehicle 610 and that no obstacles were found during the manual search.

The clear hazard mode may represent an intermediate mode in that the clear hazard mode may comprise a period of time for a local operator to exit the hazard zone 640. Because the clear hazard mode may be enabled or required to be activated locally at the autonomous work vehicle 610, the local operator may require time to exit the hazard zone 640 after the second operator input has been received prior to autonomous operation of the autonomous work vehicle 610. To account for this, when the clear hazard mode is activated, the system may initiate a secondary timer—i.e., a clearing timer—to provide time for the local operator to exit the hazard zone 640. The clearing timer may count to or from an amount of time sufficient to enable the operator to leave the hazard zone 640, such as an amount of time of 15, 30, 45, 60, 75, 90, 105, 120, 180, 240, or 300 seconds, or an amount of time within a range having any two of the foregoing values as endpoints. The amount of time of the secondary timer may be adjustable within the settings of the system.

The autonomous work vehicle 610 may be instructed to produce a signal, such as an audio alarm (e.g., beeping or a siren) throughout, at the beginning, or near the end of the time period of the clearing timer to alert the local operator that the clearing timer has begun or is near an end and to exit the hazard zone 640. Additionally, or alternatively, the signal may comprise a light, such as flashing lights, emergency lights, or auxiliary lights, to similarly alert the local operator of the beginning and/or end of the time period of the clearing timer. The process 700 may then proceed to step 740 for autonomous operation of the autonomous work vehicle 610.

In some embodiments, activation of the clear hazard mode may automatically induce the autonomous vehicle system to clear the hazard grid, such that all indications of obstacles within the hazard zone 640 (and/or other portions of the operating environment) are removed from the hazard grid. This may ensure that all indications of obstacles within the hazard zone 640 are newly identified—that all indications of obstacles within the hazard zone 640 are generated based on the reception of visual sensor signal data generated in the future. This may ensure that the indications of obstacles within the hazard zone accurately represent obstacles actually present within the hazard zone 640.

If the hazard grid is successfully cleared the process 700 may continue to step 740. If the hazard grid is not successfully cleared the process may continue to step 760 for local confirmation. In such instances, an alert may be presented at the autonomous work vehicle 610 or sent to a remote device indicating that the hazard grid could not be cleared. This may indicate to an operator that a reboot of the system, or other action, may be required to clear the hazard grid and ensure effective performance of the autonomous work vehicle 610.

In some embodiments, the hazard grid may be cleared after a buffer period subsequent to activating the clear hazard mode. For example, the hazard grid may be cleared after the clearing timer has expired. In other embodiments, the hazard grid may be cleared concurrently or immediately after activation of the clear hazard mode. In such instances, the autonomous work vehicle 610 may rely upon the hazard grid, after it has been cleared to ensure that the local operator has exited the hazard zone 640. After the hazard grid has successfully been cleared, the hazard grid may be relied upon to indicate the location of the operator and when the operator exits the hazard zone 640. Alternatively, or additionally, the process 700 may not proceed until third operator input is received remotely from beyond the hazard zone (e.g., via a remote device) indicating that the local operator has exited the hazard zone 640 and that autonomous operation is safe. The hazard grid may not be cleared until the local operator has exited the hazard zone 640, for example, such as indicated by the visual sensor signal data.

The process 700 may proceed to step 740, for example, when the clearing timer has expired, when the hazard grid has been cleared, and/or when the visual sensor signal data or other input indicates that the local operator (or any other obstacles) have exited the hazard zone 640. Activation of the autonomous mode may enable full autonomous operation of the autonomous work vehicle 610, such that instructions sent by the VCU 220 (e.g., to the steering and/or speed control systems) may result in autonomous driving of the autonomous work vehicle 610 (and/or autonomous control of an implement connected to the autonomous work vehicle 610).

Simultaneously with activation of the autonomous mode, the system may deactivate the e-stop mode to enable movement of the autonomous work vehicle 610 and to enable the VCU 220 to instruct the steering and speed control systems. Alternatively, the e-stop mode may be deactivated previously (e.g., during the clear hazard mode after a manual search has been successfully performed). When the autonomous mode is activated, the clear hazard mode may be deactivated (e.g., to prevent automatic clearing of the hazard grid) and the autonomous work vehicle 610 may continue autonomous operation to perform the operational task. The autonomous vehicle system may continue to search for obstacles within the operating environment (e.g., based on the visual sensor signal data). This may be represented within process 700 as step 745. At step 745, the process 700 may determine if an obstacle is detected within the hazard zone 640. If no obstacle is detected within the hazard zone 640 the autonomous work vehicle 610 may continue with the active status of the autonomous mode, such that the autonomous work vehicle 610 may continue autonomous operation.

If an obstacle is detected within the hazard zone 640, the process 700 may proceed to step 750 wherein the autonomous mode is deactivated such that autonomous operation of the autonomous work vehicle 610 is ended. In this manner, obstacles detected within the hazard zone 640 posing substantial risk of collision to the autonomous work vehicle 610 and/or resultant harm to the autonomous work vehicle 610 and/or the obstacle may be prevented. During normal autonomous operation, the autonomous work vehicle 610 may be driven to avoid obstacles (e.g., by adjusting a speed of the autonomous work vehicle 610 or selecting a different path) and prevent obstacles from entering the hazard zone 640. When an obstacle enters the hazard zone 640 the autonomous work vehicle 610 may be instructed to stop (e.g., immediately) and to end autonomous operation (by deactivating the autonomous mode of the autonomous work vehicle 610). This may reduce the risk of harm to the autonomous work vehicle 610 and/or the obstacle.

In some embodiments, after an obstacle is detected and the process 700 proceeds, step 750 may comprise generating an image of the obstacle. The image may be generated by a visual sensor, such as a video camera, connected to the autonomous work vehicle 610, or generated based on the visual sensor signal data. The image of the obstacle may then be sent to a remote device (e.g., for viewing by a remote operator). In some embodiments, the generated image of the obstacle may be a portion of a video of the operating environment generated by the visual sensor. The image of the obstacle may be viewed by a remote operator for determining the type of obstacle, the level of risk posed by the obstacle, and/or for remote control of the autonomous work vehicle 610.

When the hazard timer expires at step 725, when the hazard grid fails to be cleared at step 735, or when an obstacle is detected within the hazard zone 640 at step 745 (and, for example, an image of the obstacle is generated at step 750), the process may continue to step 760 for local confirmation. At local confirmation, the system may act on the presumption that an obstacle is or may be present within the hazard zone 640 and that verification that obstacles have left or are no longer within the hazard zone 640 may only be confirmed locally, for example, by a local operator within the hazard zone 640. At step 760, the clear hazard mode may be disabled, such that the clear hazard mode may not be activated (indicating that only local confirmation can verify the absence of obstacles within the hazard zone 640) and the autonomous mode may be disabled.

From step 760, the process 700 may continue back to step 710 wherein the e-stop mode is activated (or re-activated). Once the e-stop mode is activated, the autonomous work vehicle 610 may return to an active autonomous mode through (e.g., may return only through) local confirmation of the hazard zone 640 by a local operator, beginning again at step 715.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented or steps disclosed in the examples above can be varied-for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous work vehicle comprising:
a steering control system for autonomously controlling a driving direction of the autonomous work vehicle;
a speed control system for autonomously controlling a speed of the autonomous work vehicle;
one or more sensors, including a visual sensor;
one or more processors communicatively coupled with the one or more sensors, the steering control system, and the speed control system; and
one or more computer-readable media having stored thereon instructions that when executed cause the one or more processors to:
activate an e-stop mode of the autonomous work vehicle, wherein activation of the e-stop mode prevents autonomous movement of the autonomous work vehicle;
receive first operator input indicating a beginning of a manual search for obstacles within a hazard zone, wherein the hazard zone comprises an area within a virtual representation of an operating environment surrounding the autonomous work vehicle;
after receiving first operator input, deactivate the e-stop mode and initiate a hazard timer;
receive second operator input indicating no obstacles were found during the manual search within the hazard zone; and
when second operator input is received before the hazard timer expires, activate a clear hazard mode of the autonomous work vehicle such that the one or more processors:
clear a hazard grid, wherein the hazard grid comprises a virtual representation of obstacles within the hazard zone, and wherein clearing the hazard grid removes all indications of obstacles within the hazard grid such that detection of obstacles is based only on reception of future visual sensor signal data;
receive visual sensor signal data from the visual sensor indicating whether an obstacle is present within the hazard zone; and
when no obstacles are detected within the hazard zone based on the visual sensor signal data, activate an autonomous mode of the autonomous work vehicle and instruct the steering control system and the speed control system to drive the autonomous work vehicle along a path through the operating environment based on the visual sensor signal data.

2. The autonomous work vehicle of claim 1, wherein the instructions further cause the one or more processors, after the hazard grid is cleared and when visual sensor signal data indicate an obstacle within the hazard zone, to re-activate the e-stop mode of the autonomous work vehicle.

3. The autonomous work vehicle of claim 1, wherein the instructions further cause the one or more processors, when the hazard timer expires before receiving the second operator input, to activate the e-stop mode of the autonomous work vehicle.

4. The autonomous work vehicle of claim 1, wherein activation of the e-stop mode prevents autonomous operation of an implement connected to the autonomous work vehicle.

5. The autonomous work vehicle of claim 1, wherein a sensor field of view of the visual sensor extends over at least a portion of the operating environment that corresponds to a circumference of the hazard zone within the representation of the operating environment.

6. The autonomous work vehicle of claim 1, wherein when the clear hazard mode is active, activation of the autonomous mode is prevented until any and all operators have left the hazard zone.

7. The autonomous work vehicle of claim 6, wherein the activation of the clear hazard mode further comprises initiating a clearing timer, and wherein the instructions further cause the one or more processors to activate the autonomous mode when no obstacles are detected within the hazard zone at or near a time the clearing timer expires.

8. The autonomous work vehicle of claim 6, wherein the instructions further cause the one or more processors to, when the clear hazard mode is active, activate the autonomous mode based on input from a remote device.

9. The autonomous work vehicle of claim 1, wherein the first operator input comprises pressing a button of the autonomous work vehicle.

10. The autonomous work vehicle of claim 1, wherein the instructions further cause the one or more processors to, after activating the autonomous mode, when the visual sensor signal data indicates an obstacle is present within the hazard zone, re-activating the e-stop mode of the autonomous work vehicle.

11. The autonomous work vehicle of claim 1, wherein the hazard zone extends within the virtual representation to areas corresponding to between 5 feet and 10 feet from the autonomous work vehicle.

12. The autonomous work vehicle of claim 1, wherein the hazard zone extends, within the virtual representation, further from a front of the autonomous work vehicle than from a rear of the autonomous work vehicle.

13. The autonomous work vehicle of claim 1, wherein the hazard zone extends within the virtual representation to areas adjacent to the autonomous work vehicle.

14. A method for confirming absence of obstacles near an autonomous work vehicle, the method comprising:
activating an e-stop mode of the autonomous work vehicle, wherein activation of the e-stop mode prevents autonomous movement of the autonomous work vehicle;
receiving first operator input indicating a beginning of a manual search for obstacles within a hazard zone, wherein the hazard zone comprises an area within a virtual representation of an operating environment surrounding the autonomous work vehicle;
after receiving first operator input, deactivating the e-stop mode and initiating a hazard timer;
receiving second operator input indicating no obstacles were found during the manual search within the hazard zone; and
when second operator input is received before the hazard timer expires:
clearing a hazard grid, wherein the hazard grid comprises a virtual representation of obstacles within the hazard zone, and wherein clearing the hazard grid removes all indications of obstacles within the hazard grid such that detection of obstacles is based only on reception of future visual sensor signal data;
receiving visual sensor signal data from the visual sensor indicating whether an obstacle is present within the hazard zone; and
when no obstacles are detected within the hazard zone based on the visual sensor signal data, activating an autonomous mode of the autonomous work vehicle and instructing a steering control system and a speed control system to drive the autonomous work vehicle along a path through the operating environment based on the visual sensor signal data.

15. The method of claim 14, further comprising, when the hazard timer expires before receiving the second operator input, activating the e-stop mode of the autonomous work vehicle.

16. The method of claim 14, wherein activation of the e-stop mode prevents autonomous operation of an implement connected to the autonomous work vehicle.

17. The method of claim 14, wherein after receiving second operator input, activation of the autonomous mode is prevented until any and all operators have left the hazard zone.

18. The method of claim 17, further comprises, after receiving second operator input before expiration of the hazard timer, initiating a clearing timer and activating the autonomous mode when no obstacles are detected within the hazard zone at or near a time the clearing timer expires.

19. An autonomous work vehicle comprising:
a steering control system for autonomously controlling a driving direction of the autonomous work vehicle;
a speed control system for autonomously controlling a speed of the autonomous work vehicle;
one or more sensors, including a LiDAR sensor;
one or more processors communicatively coupled with the one or more sensors, the steering control system, and the speed control system; and
one or more computer-readable media having stored thereon instructions that when executed cause the one or more processors to:
activate an e-stop mode of the autonomous work vehicle, wherein activation of the e-stop mode prevents autonomous movement of the autonomous work vehicle;
activate a manual mode of the autonomous work vehicle, such that the autonomous work vehicle may be driven via manual input by an operator physically present at the autonomous work vehicle;
receive first operator input indicating a beginning of a manual search for obstacles within a hazard zone, wherein the hazard zone comprises an area within a virtual representation of an operating environment surrounding the autonomous work vehicle;
after receiving first operator input, deactivate and disable the e-stop mode;
receive second operator input indicating no obstacles were found during the manual search within the hazard zone; and
activate a clear hazard mode of the autonomous work vehicle such that the one or more processors:
enable the e-stop mode, such that the e-stop mode may be activated by the one or more processors when an obstacle is detected within the hazard zone;
clear a hazard grid, wherein the hazard grid comprises a virtual representation of obstacles within the hazard zone, and wherein clearing the hazard grid removes all indications of obstacles within the hazard grid such that detection of obstacles is based only on reception of future visual sensor signal data;
receive visual sensor signal data from the LiDAR sensor indicating whether an obstacle is present within the hazard zone; and
when no obstacles are detected within the hazard zone based on the visual sensor signal data, activate an autonomous mode of the autonomous work vehicle and instruct the steering control system and the speed control system to drive the autonomous work vehicle along a path through the operating environment based on the visual sensor signal data.

20. The autonomous work vehicle of claim 19, wherein when the clear hazard mode is active, activation of the autonomous mode is prevented until any and all operators have left the hazard zone.
